(19) United States
(12) Patent Application Publication
(10) Pub. No.: US 2013/0150022 A1
(43) Pub. Date: Jun. 13, 2013

(54) SMALL BASE STATION AND METHOD FOR PROVIDING SELF-ORGANIZING NETWORK (SON) FOR SMALL BASE STATION

(71) Applicant: Electronics and Telecommunications Research In, Daejeon (KR)

(72) Inventors: Chan Yong LEE, Daejeon (KR); Eun Seon CHO, Daejeon (KR); Hong Soog KIM, Daejeon (KR); Hyeon Ju OH, Daejeon (KR); Byung Han RYU, Daejeon (KR); Nam Hoon PARK, Daejeon (KR)

(73) Assignee: Electronics and Telecommunications Research Institute, Daejeon (KR)

(21) Appl. No.: 13/677,758

(22) Filed: Nov. 15, 2012

(30) Foreign Application Priority Data
Dec. 7, 2011 (KR) 10-2011-0130151

(51) Int. Cl. H04W 84/18

(52) U.S. Cl. CPC H04W 84/18
USPC 455/422.1

(57) ABSTRACT

Provided are a small base station, and a method for providing a Self-Organizing Network (SON) for the small base station. There is provided a small base station including: a server configured to receive a session establishment request message from a control unit, and to generate a session establishment request event; a message conversion engine configured to receive, after a session with the control unit is established, an information request message from the control unit, to analyze the information request message to provide the results of the analysis, and to convert response information that is to be transmitted to the control unit, into a format of a predetermined message; and a session manager configured to manage the session with the control unit in response to the session establishment request event, and to provide the response information corresponding to the results of the analysis.

### CLAIM FOR PRIORITY

This application claims priority to Korean Patent Application No. 10-2011-0130151 filed on Dec. 7, 2011 in the Korean Intellectual Property Office (KIPO), the entire contents of which are hereby incorporated by reference.

### BACKGROUND

1. Technical Field

An example embodiment of the present invention relates in general to a mobile communication system, and more specifically, to a small base station and a method for providing a Self-Organizing Network (SON) for the small base station.

2. Related Art

Recently, with development of data communication and multimedia technology, requirements for new mobile communication services are increasing, and with development of wire-wireless communication technology, a small base station as wire-wireless convergence technology is attracting attention.

A small base station is a base station for mobile communication, which is mainly used in an indoor environment, such as a home, office, etc. The small base station attracts worldwide telecommunication companies since it can remove shadow regions and be used as an indoor communication infrastructure for wire-wireless convergence services. Communication standardization for the small base station is proceeding as included in the 3GPP LTE (3^{rd} Generation Partnership Project Long Term Evolution) and IEEE (Institute of Electrical and Electronics Engineers) 802.16.

A small base station converges to a digital subscriber line (DSL), a cable broadband connection, or an optical cable gateway so that a user can connect the small base station to an Internet Protocol (IP)-based broadband network in the home or small entity to use wire-wireless communication through his or her mobile phone. Also, since a base station can transmit mobile communication data directly to the coverage of a small base station not via an indoor relay, telecommunication providers can reduce frequency loads and improve Quality of Service (QoS), while lowering network establishment cost.

Meanwhile, since a small base station has to be installed and managed by a user, instead of being installed at an optimal location designated by a mobile communication operator, the mobile communication operator cannot design the spatial arrangement of cells, and the small base station itself has to detect its surroundings and perform self-configuration and self-optimization.

In order to meet the requirement, the 3GPP LTE or LTE-Advanced standard is standardizing a self-organizing network (SON) for auto-configuration and auto-operation of a small base station which is Customer Premises Equipment (CPE) through interworking with SON equipment which is an Auto Configuration Server (ACS) for remotely controlling subscriber equipment.

SON capabilities for the small base station include self-configuration, self-optimization, and self-healing.

The self-configuration is to collect and analyze parameters needed for initial operation of a base station when the base station is newly installed, and to automatically perform, before the initial booting and operation of the base station, a procedure for identifying and registering neighboring base stations, setting a relationship with the neighboring base stations, and performing a connection setup with a core network.

The self-optimization includes signal intensity control for minimizing interference between neighboring base stations based on signal and traffic type information upon operation, management, and repair of a base station, Random Access CHannel (RACH) optimization, handover parameter optimization for minimizing Radio Link Failure (RLF) upon handover, evenly distributing loads between neighboring base stations, power saving of minimizing the operation times of unnecessary base stations, etc. The base station can perform self-configuration and self-optimization by interworking with an ACS.

The self-healing is to recover, when faulty components are found in a base station, ones that can be automatically recovered among the faulty components, thereby eliminating or minimizing errors. For example, the self-healing monitors alarms that are generated when failure is detected in a small base station, collects, when an alarm is generated, related information through measurement or analysis, and then recovers the failure if automatic recovery is possible.

Through the SON capabilities as described above, a user can easily perform initial-configuration and optimization of a small base station only by purchasing the small base station, connecting the small base station to an IP-based broadband network, and supplying power to the small network.

However, neither a small base station configuration for implementing SON capabilities as described above nor an operation method of the small base station that interworks with SON equipment for remotely controlling the small base station have been proposed so far. Accordingly, for commercialization of the small base station, a small base station configuration for implementing SON capabilities and an operation method of the small base station need to be proposed.

### SUMMARY

Accordingly, example embodiments of the present invention are provided to substantially obviate one or more problems due to limitations and disadvantages of the related art.

An example embodiment of the present invention provides a small base station having self-organizing network (SON) capabilities.

Another example embodiment of the present invention provides a method in which a small base station performs SON capabilities.

In an example embodiment, there is provided a small base station including: a server configured to receive a session establishment request message from a control unit, and to generate a session establishment request event; a message conversion engine configured to receive, after a session with the control unit is established, an information request message from the control unit, to analyze the information request message, provide the results of the analysis, and to convert response information that is to be transmitted to the control unit, into a format of a predetermined message; and a session manager configured to manage the session with the control unit in response to the session establishment request event, and to provide the response information corresponding to the results of the analysis.

The information request message received from the control unit may be an information request message for auto-configuration and auto-operation, and the message conversion engine may analyze the information request message for auto-configuration and auto-operation, provide the results of the analysis to the session manager, and convert the response information into a Simple Object Access Protocol (SOAP) message.

The session manager may establish, if an event needing to be transmitted to the control unit is generated in the small base station, a session with the control unit.

The small base station may further include: a process manager configured to initialize data for environment setting when the small base station is initially installed, and to control operation of the server and the session manager; and a Remote Procedure Call (RPC) processor configured to process an RPC method called by the session manager.

The small base station may further include: a file transmitter configured to transmit, when a file transmission event is generated by the session manager, the corresponding file based on location information received from the control unit; an internal process manager configured to process a message related to auto-configuration or auto-operation of the small base station; and a data relay configured to relay the message related to auto-configuration or auto-operation of the small base station, the message transmitted between the internal processor and the control unit.

The small base station may further include: a system information collector configured to collect information related to the state or Operating System (OS) of the small base station, in response to an event generated at predetermined time intervals or in response to a request from the control unit, and to provide the collected information to the session manager; an eXtensible Markup Language (XML) data parsing unit configured to process an XML file in response to a call from the session manager or the data relay; and a system information provider configured to transmit the information collected by the system information collector to the control unit.

If the data relay detects an event indicating that the control unit has corrected a value included in an auto-configuration or auto-operation message, the data relay may provide the corrected value to the XML data parsing unit, and the XML data parsing unit may update an existing XML file to an XML file to which the corrected value has been reflected.

In another example embodiment, there is provided a method of providing a Self-Organizing Network (SON) for a small base station, including: starting a session with a control unit in response to a session event; transmitting request information for auto-configuration or auto-operation to the control unit; and receiving response information corresponding to the request information from the control unit.

The transmitting of the request information for auto-configuration or auto-operation to the control unit may include transmitting an RPC method corresponding to auto-configuration or auto-operation to the control unit.

After receiving the response information corresponding to the request information from the control unit, the method may further include: receiving a predetermined message from the control unit; analyzing the predetermined message; and calling a Remote Procedure Call (RPC) method corresponding to the results of the analysis on the predetermined message.

In another example embodiment, there is provided a method of providing a Self-Organizing Network (SON) for a small base station, including: verifying a message received from a control unit; performing, if the received message is either an auto-configuration message or an auto-operation message, processing corresponding to the received message; and determining whether the results of the processing on the received message have to be notified.

After the verifying of the received message, the method may further include performing, if it is determined that the received message is neither an auto-configuration message nor an auto-operation message, error reporting.

The determining of whether the results of the processing on the received message have to be notified may include notifying the control unit of the results of the processing, or processing the results of the processing in the small base station.

According to the small base station and the method of providing the SON for the small base station, the configuration and operation of the small base station that performs SON capabilities including auto-configuration and auto-operation are provided.

Accordingly, it is possible to stably set initial configuration parameters for auto-configuration of a small base station through interworking with a SON apparatus, and also to efficiently optimize configuration parameters upon auto-operation of the small base station.

Also, it is possible to improve the cell environment of a mobile communication system through auto-configuration and auto-operation, and to adaptively reduce handover failure. In addition, by minimizing interference between cells and appropriately maintaining cell coverage, it is possible to minimize a user's intervention related to management of a small base station while satisfying service requirements, thereby reducing the required cost for maintenance and repair.

### BRIEF DESCRIPTION OF DRAWINGS

Example embodiments of the present invention will become more apparent by describing in detail example embodiments of the present invention with reference to the accompanying drawings, in which:

FIG. 1 is a conceptual view illustrating a network environment where small base stations are installed.

FIG. 2 is a block diagram illustrating a small base station according to an embodiment of the present invention.

FIG. 3 is a flowchart illustrating a method of processing a request related to an auto-configuration and auto-operation message for a small base station, according to an embodiment of the present invention.

FIG. 4 is a flowchart illustrating a method of controlling an auto-configuration and auto-operation message for a small base station, according to an embodiment of the present invention.

### DESCRIPTION OF EXAMPLE EMBODIMENTS

Example embodiments of the present invention are described below in sufficient detail to enable those of ordinary skill in the art to embody and practice the present invention.

It is important to understand that the present invention may be embodied in many alternate forms and should not be construed as limited to the example embodiments set forth herein.

The terminology used herein to describe embodiments of the invention is not intended to limit the scope of the invention. The articles “a,” “an,” and “the” are singular in that they have a single referent, however the use of the singular form in the present document should not preclude the presence of more than one referent. In other words, elements of the invention referred to in the singular may number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

Unless otherwise defined, all terms (including technical and scientific terms) used herein are to be interpreted as is customary in the art to which this invention belongs. It will be further understood that terms in common usage should also be interpreted as is customary in the relevant art and not in an idealized or overly formal sense unless expressly so defined.

In the following description, a “small base station” may be referred to as another word, such as a femtocell base station, a femto base station, a small-size base station, an indoor base station, a home base station, ultra-compact wireless access network equipment, Home NodeB (HNB), Home eNodeB (HeNB), Femto Access Point (FAP), Femto Base Transceiver Station (BTS), Wibro/WiMax Femto Access Point (WFAP), etc. Also, a “macro cell” is a cell that is managed by a macro base station, and a macro base station may operate one or more macro cells. Specifically, in the following description, a macro base station may be an arbitrary base station that is managed by a communication network operator or a service provider.

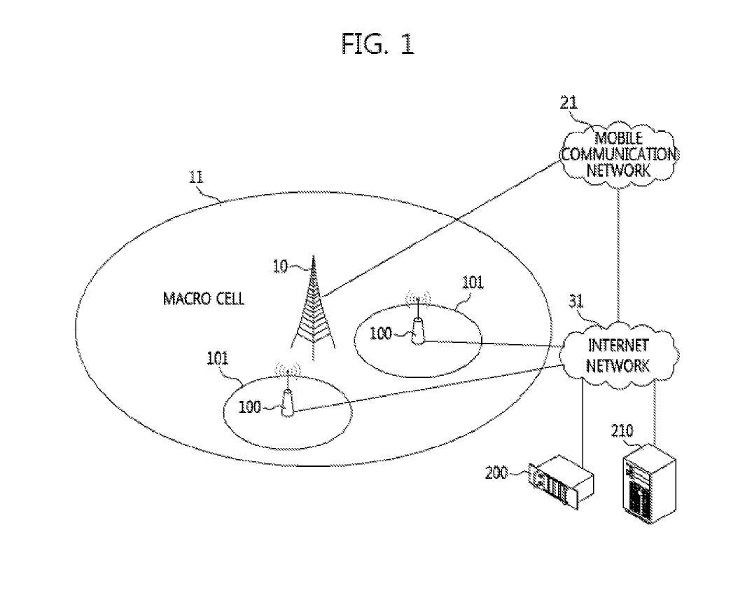

FIG. 1 is a conceptual view illustrating a network environment where small base stations (100 for each) are installed.

Referring to FIG. 1, the small base stations 100 may be placed in a macro cell which is a service region of a macro base station 10. That is, a plurality of small base stations may be placed in a macro cell. Here, the macro base station 10 is a base station that is managed by a mobile communication operator. The macro base station 10 manages at least one macro cell 11, and connects to a mobile communication network 21 to provide mobile communication services.

Each small base station 100 which is Customer Premises Equipment (CPE), may be installed in an indoor environment, such as a home or office, by a user, and manages at least an ultra-compact cell (for example, a femto cell).

Also, the small base station 100 connects to an Internet network 31 through an IP-based broadband network, and connects to a mobile communication network 21 that is managed by a mobile communication operator, through the Internet network 31.

Also, the small base station 100 may be connected to a Self-Organizing Network (SON) apparatus 200 which is a SON server, through the Internet network 31. The SON apparatus 200 transmits auto-configuration information and auto-operation information required for a SON network of the small base station 100, to the small base station 100, through the Internet network 31, and the small base station 100 may execute SON capabilities based on the auto-configuration information and auto-operation information.

The file server 210 may be connected to the small base station 100 and the SON apparatus 200 through the Internet network 31, and store auto-configuration information, auto-operation information, etc. that the small base station 100 needs to perform SON capabilities.

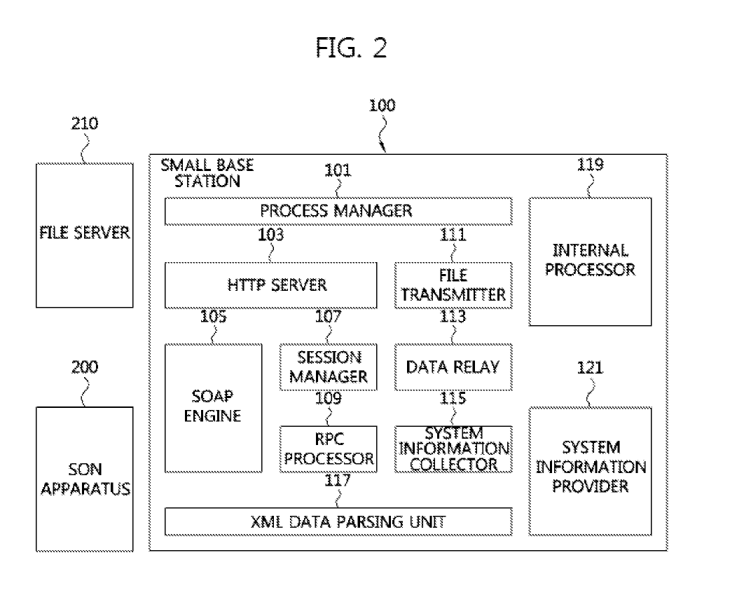

FIG. 2 is a block diagram illustrating the small base station 100 according to an embodiment of the present invention, and shows a configuration of the small base station 100 that can perform SON capabilities including self-configuration, self-optimization, etc.

Referring to FIG. 2, the small base station 100 may include a process manager 101, a HyperText Transfer Protocol (HTTP) server 103, a Simple Object Access Protocol (SOAP) engine 105, a session manager 107, a Remote Procedure Call (RPC) processor 109, a file transmitter 111, a data relay 113, a system information collector 115, an eXtensible Markup Language (XML) data parsing unit 117, an internal processor 119, and a system information provider 121.

The process manager 101 initializes, when the small base station 100 is initially installed, environment setting-related data, controls the HTTP server 103, the session manager 107, the file transmitter 111, the data relay 113, and the system information collector 115 for auto-configuration and auto-operation, or monitors an operation termination event of the small base station 100, releases, when an operation terminal event is generated, resources allocated upon initialization, and performs a control for terminating driving of the individual components.

The HTTP server 103 receives a session establishment request message from the SON apparatus 200, and generates a session establishment request event in response to the session establishment request message. Here, the session establishment request message may be transmitted from the SON apparatus 200 when the SON apparatus 200 tries to establish a session with the small base station 100 in order to process messages related to auto-configuration and auto-operation of the small base station 100, and the session establishment request message may be a HTTP GET request.

If a request for information related to auto-configuration and auto-operation is received from the SON apparatus 200 after a session is established between the SON apparatus 200 and the small base station 100, the SOAP engine 105 analyzes the request, transfer the results of the analysis to the session manager 107, converts response information corresponding to the request from the SON apparatus 200, provided from the session manager 107, into a SOAP message, and then transfers the SOAP message to the SON apparatus 200.

If a response corresponding to a request from the SON apparatus 200 has to be transmitted to the SON apparatus 200 or if a predetermined event generated by the small base station 100 has to be notified to the SON apparatus 200, the session manager 107 establishes a session for communication with the SON apparatus 200 and manages the session. Also, the session manager 107 detects an event generated in the small base station 100 and performs processing corresponding to the detected event.

The RPC processor 109 processes an RPC method called by the session manager 107. For example, if a SOAP message is received from the SON apparatus 200 when a session is established between the SON apparatus 200 and the small base station 100, the SOAP engine 105 analyzes the SOAP message and provides the results of the analysis to the session manager 107, the session manager 107 calls a predetermined RPC method based on the results of the analysis, and the RPC processor 109 processes the RPC method called by the session manager 107.

If an RPC method related to download or upload is called by the session manager 107, the file transmitter 111 transmits or receives a file related to auto-configuration and auto-operation in response to the RPC method.

For example, if the SON apparatus 200 calls an RPC method related to upload or download and a file transmission event corresponding to the RPC method is generated by the session manager 107, the file transmitter 111 transmits the corresponding file to a location to which the file will be transmitted in the file server 210, or downloads the file from the corresponding location of the file server 210, wherein information about the location which the file will be transmitted to or downloaded from is notified from the SON apparatus 200. If transmission or reception of the file is complete, the file transmitter 111 generates a transmission completion event so that the session manager 107 detects the transmission completion event and notifies the SON apparatus 200 of the results of the file transmission.

The data relay 113 functions to relay auto-configuration and auto-operation messages between the internal processor 119 and the SON apparatus 200. For example, when the SON apparatus 200 corrects a specific value included in an auto-configuration and auto-operation message, the session manager 107 generates the corresponding event, and the data processor 113 detects the event and transfers the corrected value to the internal processor 119. Also, the data relay 113 provides the corrected value to the XML data parsing unit 117 so that the XML data parsing unit 117 updates an existing XML file to an XML file including the corrected value. Also, the data relay 113 generates, when it transmits data from the internal processor 119 to the SON apparatus 200, the corresponding event so that the session manager 107 detects the event, and calls and uses it.

The system information collector 115 collects specific data related to the state and OS of the small base station 100, in response to a request that is periodically generated in the small base station 100, a request from the internal processor 119, or a request from the SON apparatus 200, according to a predetermined collection policy, and notifies the results of the collection to the SON apparatus 200 through the session manager 107. If a request for collecting a specific value is received from the SON apparatus 200, the session manager 107 generates an event corresponding to the request, and the system information collector 115 detects the generated event and collects the specific value.

The XML data parsing unit 117 functions to control or manage XML files through an XML parser in response to a request from the session manager 107, the data relay 113, or the system information collector 115.

The internal processor 119 functions to process or transmit auto-configuration and auto-operation messages, or to transmit or receive processed data.

The system information provider 121 collects data related to the state and OS of the small base station 100 from the system information collector 115, and provides the collected data to the SON apparatus 200.

Hereinafter, a method of providing SON capabilities of the small base station 100, according to an embodiment of the present invention, will be described with reference to FIG. 2.

If the small base station 100 receives a predetermined request message from the SON apparatus 200, the small base station 100 performs processing corresponding to the predetermined request message, and transmits a response message for notifying of the results of the processing to the SON apparatus 200. Also, the small base station 100 transmits events generated by itself to the SON apparatus 200.

In detail, if the SON apparatus 200 requests the small base station 100 to send an auto-configuration and auto-operation related message, the HTTP server 103 of the small base station 100 receives the request, and generates an event corresponding to the request. The session manager 107 detects the event generated by the HTTP server 103, and establishes a session with the SON apparatus 200.

The SOAP engine 105 removes a header/body of a SOAP message received from the SON apparatus 200, and provides the resultant SOAP message to the session manager 107. The session manager 107 calls an RPC method in response to the SOAP message, and the RPC processor 109 performs processing corresponding to the RPC method, and then transmits the processed data to the data relay 113. The data relay 113 transmits the received data to the internal processor 119 so that the internal processor 119 processes the received data.

Also, a method of transmitting an event generated by the internal processor 119 to the SON apparatus 200 is as follows:

If an event is generated by the internal processor 119 and the internal processor 119 transmits the event-related data to the data relay 113, the data relay 113 calls the event corresponding to the event-related data. The session manager 107 detects the event and calls an RPC method, and then the RPC processor 109 performs processing corresponding to the RPC method and provides the results of the processing to the SOAP engine 105. The SOAP engine 105 adds a header/body of a SOAP message to the results of the processing, and transmits the resultant data to the SON apparatus 200 through the HTTP server 103. Here, the XML data parsing unit 117 accesses a XML file through the XML parser according to the RPC method to thereby inquire about or set a desired value.

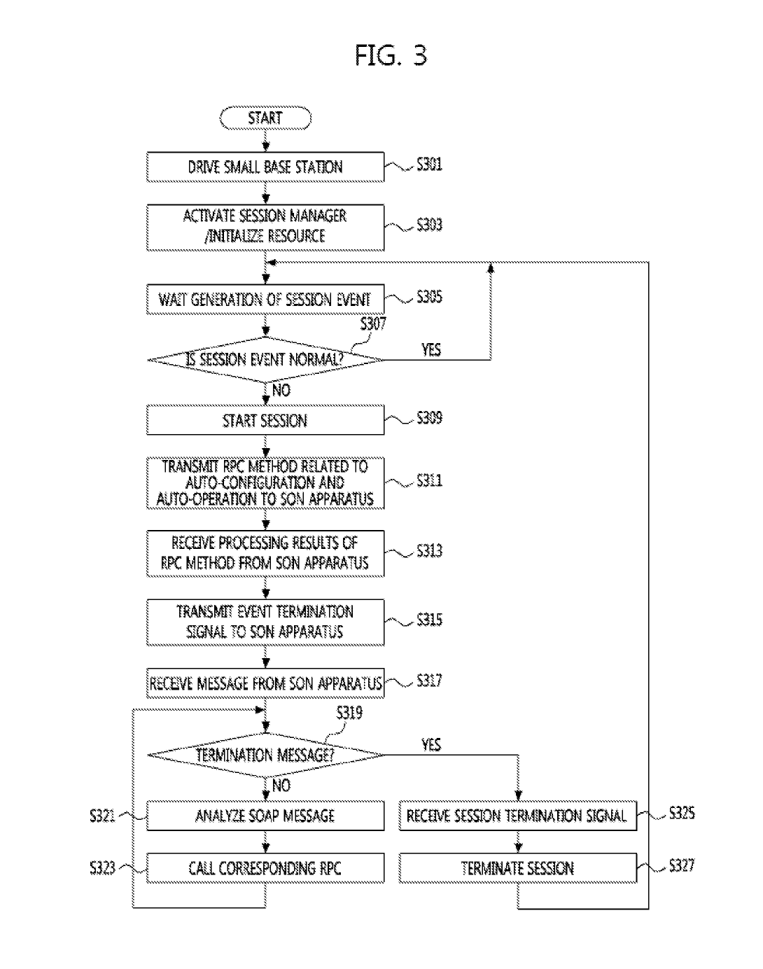

FIG. 3 is a flowchart illustrating a method of processing a request related to an auto-configuration and auto-operation message for a small base station, according to an embodiment of the present invention, wherein the method corresponds to a message processing procedure that is performed by the session manager 107 of the small base station 100.

Referring to FIGS. 2 and 3, first, if the base station 100 is driven (S301), the session manager 107 for processing and transmitting a message for auto-configuration and auto-operation of the small base station 100 and initializing a resource for supporting the processing and transmission of the auto-configuration and auto-operation message, is activated (S303).

Then, the session manager 107 waits until a session event is generated, while monitoring generation of a session event (S305).

Thereafter, if the session manager 107 detects generation of a session event, the session manager 107 analyzes the session event to select and verify the session event, thereby determining whether the session event is normal (S307). If it is determined that the session event is abnormal, the session manager 107 returns to operation 5305 to wait until another session event is generated. Meanwhile, if it is determined that the session event is normal, the session manager 107 starts a session (S309).

Thereafter, the session manager 107 transmits an RPC method related to auto-configuration and auto-operation, as an event, to the SON apparatus 200 (S311), and receives the processing results of the RPC method from the SON apparatus 200 (S313). Also, if processing of the event is no longer needed, the session manager 107 transmits an event termination signal to the SON apparatus 200 (S315).

Then, the session manager 107 receives a message from the SON apparatus 200 (S317), and determines whether the received message is a message indicating termination of the session (S319).

If it is determined that the received message is not a message indicating termination of the session, the session manager 107 analyzes the received message (S321), calls the corresponding RPC method based on the results of the analysis (S323), and returns to operation 5319 to execute the following operations.

Meanwhile, if it is determined that the received message is a message indicating termination of the session, the session manager 107 receives a session termination signal (S325), terminates the session with the SON apparatus 200, and returns to operation 5305 to execute the following operations.

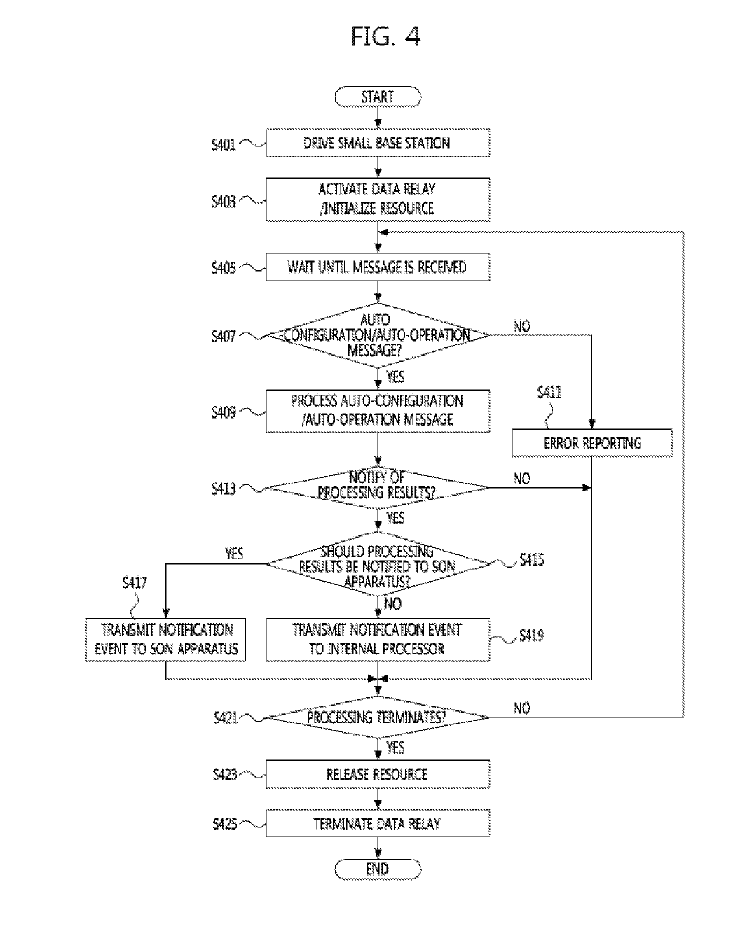

FIG. 4 is a flowchart illustrating a method of controlling an auto-configuration and auto-operation message for a small base station, according to an embodiment of the present invention, wherein the method corresponds to a processing procedure that is performed by the data relay 113 of the small base station 100.

Referring to FIGS. 2 and 4, first, if the base station 100 is driven (S401), the data relay 113 for processing and transmitting a message for auto-configuration and auto-operation of the small base station 100 and initializing a resource for supporting the processing and transmission of the auto-configuration and auto-operation message, is activated (S403).

Thereafter, the data relay 113 waits until a message is received (S405), and determines, if a message is received from the SON apparatus 200, whether the received message is an auto-configuration or auto-operation message. If the received message is neither an auto-configuration message nor an auto-operation message, the data relay 113 performs error reporting (S411).

Meanwhile, if the received message is an auto-configuration or auto-operation message, the data relay 113 processes the auto-configuration or auto-operation message (S409).

Then, the data relay 113 determines whether to notify the processing results of the received message, based on the processing results of the auto-configuration or auto-operation message (S413), and if notification of the processing results of the received message is needed, the data relay 113 decides a target to which the processing results of the received message have to be notified (S415). Meanwhile, if no notification of the processing results of the received message is needed, the process proceeds to operation 5421, and the data relay 113 determines whether to terminate the processing.

If the target to which the processing results of the received message have to be notified is decided as the SON apparatus 200, the data relay 113 transmits a notification event to the SON apparatus 200 (S417).

Meanwhile, if the target to which the processing results of the received message have to be notified is decided as the internal processor 119, the data relay 113 transmits a notification event to the internal processor 119 (S419).

Thereafter, the data relay 113 determines whether the processing has to terminate (S421). If the processing does not have to terminate, the data relay 113 returns to operation S405, and performs the following operations. At this time, the data relay 113 may determine whether the processing has to terminate, based on a termination event signal received from the process manager 101.

Meanwhile, if the processing has to terminate, the data relay 113 releases the corresponding allocated resource (S423), and terminates the processing (S425).

While the example embodiments of the present invention and their advantages have been described in detail, it should be understood that various changes, substitutions and alterations may be made herein without departing from the scope of the invention.

What is claimed is:

1. A small base station comprising:
a server configured to receive a session establishment request message from a control unit, and to generate a session establishment request event;
a message conversion engine configured to receive, after a session with the control unit is established, an information request message from the control unit, to analyze the information request message to provide the results of the analysis, and to convert response information that is to be transmitted to the control unit, into a format of a predetermined message; and
a session manager configured to manage the session with the control unit in response to the session establishment request event, and to provide the response information corresponding to the results of the analysis.

2. The small base station of claim 1, wherein the information request message received from the control unit is an information request message for auto-configuration and auto-operation, and the message conversion engine analyzes the information request message for auto-configuration and auto-operation, provides the results of the analysis to the session manager, and converts the response information into a Simple Object Access Protocol (SOAP) message.

3. The small base station of claim 1, wherein the session manager establishes, if an event needing to be transmitted to the control unit is generated in the small base station, a session with the control unit.

4. The small base station of claim 1, further comprising:
a process manager configured to initialize data for environment setting when the small base station is initially installed, and to control operation of the server and the session manager; and
a Remote Procedure Call (RPC) processor configured to process an RPC method called by the session manager.

5. The small base station of claim 1, further comprising:
a file transmitter configured to transmit, when a file transmission event is generated by the session manager, the corresponding file based on location information received from the control unit;
an internal process manager configured to process a message related to auto-configuration or auto-operation of the small base station; and
a data relay configured to relay the message related to auto-configuration or auto-operation of the small base station, the message transmitted between the internal processor and the control unit.

6. The small base station of claim 5, further comprising:
a system information collector configured to collect information related to the state or Operating System (OS) of the small base station, in response to an event generated at predetermined time intervals or in response to a request from the control unit, and to provide the collected information to the session manager;
an eXtensible Markup Language (XML) data parsing unit configured to process an XML file in response to a call from the session manager or the data relay; and
a system information provider configured to transmit the information collected by the system information collector to the control unit.

7. The small base station of claim 6, wherein if the data relay detects an event indicating that the control unit has corrected a value included in an auto-configuration or auto-operation message, the data relay provides the corrected value to the XML data parsing unit, and the XML data parsing unit updates an existing XML file to an XML file to which the corrected value has been reflected.

8. A method of providing a Self-Organizing Network (SON) for a small base station, comprising:
starting a session with a control unit in response to a session event;
transmitting request information for auto-configuration or auto-operation to the control unit; and
receiving response information corresponding to the request information from the control unit.

9. The method of claim 8, wherein the transmitting of the request information for auto-configuration or auto-operation to the control unit comprises transmitting a Remote Procedure Call (RPC) method corresponding to auto-configuration or auto-operation to the control unit.

10. The method of claim 9, after receiving the response information corresponding to the request information from the control unit, further comprising:
receiving a predetermined message from the control unit;
analyzing the predetermined message; and
calling a Remote Procedure Call (RPC) method corresponding to the results of the analysis on the predetermined message.

11. A method of providing a Self-Organizing Network (SON) for a small base station, comprising:
verifying a message received from a control unit;
performing, if the received message is either an auto-configuration message or an auto-operation message, processing corresponding to the received message; and
determining whether the results of the processing on the received message have to be notified.

12. The method of claim 11, after the verifying of the received message, further comprising performing, if it is determined that the received message is neither an auto-configuration message nor an auto-operation message, error reporting.

13. The method of claim 11, wherein the determining of whether the results of the processing on the received message have to be notified comprises notifying the control unit of the results of the processing, or processing the results of the processing in the small base station.
